(19) United States
(12) Patent Application Publication
(10) Pub. No.: US 2014/0122313 A1
(43) Pub. Date: May 1, 2014

(54) DYNAMIC USER INTERFACE FOR COORDINATING FUNCTIONALITY

(71) Applicants: Steven Weiss, Edgewood, WA (US); Kenneth H. Weiss, Belle Terre, NY (US); Michael B. Young, Atlanta, GA (US)

(72) Inventors: Steven Weiss, Edgewood, WA (US); Kenneth H. Weiss, Belle Terre, NY (US); Michael B. Young, Atlanta, GA (US)

(21) Appl. No.: 13/663,316

(22) Filed: Oct. 29, 2012

(51) Int. Cl. G06F 3/048; G06Q 40/04

(52) U.S. Cl. CPC G06F 3/048; G06Q 40/04
USPC 705/37; 715/856

(57) ABSTRACT

A control apparatus comprising a first control interface generating a display containing a plurality of function types and receiving a first function type selection. A second control interface generating a display containing a plurality of parameters associated with the selected function type and receiving a parameter selection. A chart interface displaying historical data for a variable and receiving a first and second cursor selection from a user interface device control and generating chart location data associated with the first and second cursor selection. A function controller receiving the location data associated with the first cursor selection and executing a second related function if the chart location data associated with the first cursor selection is within allowable location data and executing the selected function after execution of the second related function if the chart location data is within allowable location data associated with the first selected function.

### TECHNICAL FIELD

The present disclosure relates generally to user interfaces, and more specifically to a dynamic user interface for coordinating functionality between different controls on the user interface.

### BACKGROUND OF THE INVENTION

User interfaces can include multiple user-selectable controls. However, in order to avoid inadvertent activation of controls, each control is typically independently operated, and does not interact with other controls.

### SUMMARY OF THE INVENTION

A control apparatus comprising a first control interface generating a display containing a plurality of function types and receiving a first function type selection. A second control interface generating a display containing a plurality of parameters associated with the selected function type and receiving a parameter selection. A chart interface displaying historical data for a variable and receiving a first and second cursor selection from a user interface device control and generating chart location data associated with the first and second cursor selection. A function controller receiving the location data associated with the first cursor selection and executing a second related function if the chart location data associated with the first cursor selection is within allowable location data and executing the selected function after execution of the second related function if the chart location data is within allowable location data associated with the first selected function.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a user interface for providing dynamic coordinated functionality in accordance with an exemplary embodiment of the present disclosure;

FIG. 2 is a diagram of a user interface for providing dynamic coordinated functionality in accordance with an exemplary embodiment of the present disclosure;

FIG. 3 is a diagram of a user interface for providing dynamic coordinated functionality in accordance with an exemplary embodiment of the present disclosure;

FIG. 4 is a diagram of a currency bar display control in accordance with an exemplary embodiment of the present disclosure;

FIG. 5 is a diagram of a trading activities management system 500 for planning and managing trades in a variety of markets using dynamic trade management schemata in accordance with an exemplary embodiment of the present disclosure; and

FIG. 6 is a diagram of a process for managing a trade in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

FIG. 1 is a diagram of a user interface 100 for providing dynamic coordinated functionality in accordance with an exemplary embodiment of the present disclosure. User interface 100 can be implemented in hardware or a suitable combination of hardware and software, and can be a display generated by software operating on a general purpose processor.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

User interface 100 includes dynamic trading interface 102, currency pair selector 104, bar type control 106, rate panel control 108, trade point grid control 110, trade summary control 112, quick trade, parameter and trade log control 114, currency bar display control 116, time control 118 and rate control 120, each of which can be implemented as one or more objects, each having associated graphic, data and functional attributes or in other suitable manners. In addition, each object can interface with one or more other objects of user interface 100 or other user interfaces described herein.

Although the asset selected for trading is referred to as “currency pair” other suitable assets can also be used, as discussed herein.

Currency pair selector 104 generates a user-selectable control to allow a user to select a currency pair for trading. In one exemplary embodiment, currency pairs can include two different currencies that have a dynamic relationship, where the exchange rate between the currencies varies as a function of time. Likewise, a financial instrument, security instrument, equity instrument, bond, commodity, option, future, derivative or other suitable trading parameter can also or alternatively be selected.

Bar type control 106 provides user-selectable controls to allow a user to configure the bars or other suitable displays on currency bar display control 116. In one exemplary embodiment, bar type control 106 can include a bar type selector which can be implemented as a drop down list that controls whether time-based bars, tick-base bars or other suitable bars will be charted, or other suitable selector controls. Time-based bars are the traditional open-high-low-close (OHLC) bars formed after an ‘interval’ time period, such as a predetermined number of seconds, minutes, hours or other suitable time periods. Tick-based bars are formed by counting ticks and forming an OHLC bar using an ‘interval’ number of ticks, where a tick can have an associated size or minimum price change, an associated value or minimum currency value, or other suitable characteristics. Bar type control 106 can also include an interval selector, which can be implemented as a drop down list that specifies the period of time used to form one bar (for time-based bars), the number of ticks used to form one bar (for tick-based bars), or other suitable selectors. Bar type control 106 can also include a time type selector control, which can be implemented as a drop down list that specifies the unit of an interval, such as seconds, minutes, hours or other suitable units of time. Bar type control 106 can also include a set control that causes the new configuration to take effect, which causes dynamic trading interface 102 to configure itself for the indicated currency pair, sets the chart for the indicated bar type and interval, fills the chart with data, and performs other suitable functions. In one exemplary embodiment, resetting the currency pair, bar type, interval or time interval or other suitable controls can be disabled if a working trade is in progress.

Rate panel control 108 can generate risk data to show the relative risk a trader takes when entering the market. In one exemplary embodiment, risk can be calculated by taking the number of lots in the trade and multiplying it by the number of pips of risk “R” which can be calculated as the number of pips between the entry rate and the initial protective stop (IPS).

For instance, if a trade is entered with 2 lots and there are 8 pips of risk from entry to a protective stop, the risk is $160 or 8 pips times 2 lots times $10/pip. In this exemplary embodiment, an “R” value of 0.5 might represent 4 pips of movement or $80. Representing trades in percentages or multiples of “R” gives a trader a very easy way to judge how profitable a trade is. A trade with P/L of 3 “R” will have 3 times as much profit as risk. A trade with a −0.5 “R” will have lost one half of the dollars risked. These relationships are true regardless of how many dollars are being traded. In one exemplary embodiment, rate panel control 108 automatically calculates the difference in pips between an initial protective stop (which can be represented as a red line on currency bar display control 116 or in other suitable manners) and the fill rate (which can be represented as a blue line on currency bar display control 116 or in other suitable manners). Rate control panel 108 can displays this value, which is typically a constant. The only time it changes during a trade is when a trader invests (increases) a position. Upon entry of an invest order, the “R” value can be recalculated to represent the distance from the stop to the new average fill price after the position invest. “R” can be used to judge how much relative value is in a trade. Representing profit and loss in dollars or other currency (especially when trading large position sizes) can trigger an emotional reaction and cloud rational trading decisions. Viewing only the “R” value isolates the trader from viewing dollars, but still gives the trader a way to judge a trade's progress. In another exemplary embodiment, a separate control can be provided to turn the dollar values on/off.

Although the amount of an asset in a trade is referred to as “lots”, other suitable specifications of quantity, can also or alternatively be used, such as, shares, contracts, ounces or units. Likewise, while “pips” and “ticks” are used to refer to fractions of a monetary unit, such as dollars, other suitable fractions can also or alternatively be employed, such as mils.

Dynamic trading interface 102 can use “R” values for displaying trade statistics, placing trade plan targets (divest orders for some or all lots at a price that is higher than the purchase price), or for other suitable purposes. For trade statistics as the market moves, trade point grid control 110 and trade summary control 112 can display a trade's progress in both dollars and percentage of “R”. For instance, if “R” is 8 pips and a trade includes two lots, the total risk in the trade is $160. A value of 1 “R” represents 8 pips of movement, such that a trade would reach 0.5 “R” when the market moves 4 pips.

Although the value of an asset is referred to as “price”, other suitable references to measures of value can also be employed, such as exchange rate.

In another exemplary embodiment, trade plans can be calculated in terms of “R”, where dynamic trading interface 102 places profit targets when predetermined multiples of risk are reached. In one exemplary embodiment, for a trade with 8 pips, the user interface can include a control to activate a trade plan to divest the entire position when a P/L indicator is twice the value of “R”. Dynamic trading interface 102 can place a 2 times “R” target 16 pips away automatically. As such, “R” can be used to plan the risk/reward of a trade, to monitor the progress of a trade without concentrating on the dollars in the trader's PNL, can be updated to reflect the new trade dynamic if a position is increased or decreased during a trade, and can be used for other suitable purposes.

Trade point grid control 110 can include a display that contains one line for each order placed. In one exemplary embodiment, a line's text can turn bold when the order is completely filled, and partially filled orders can be displayed in normal font or in other suitable manners. The order lines can be sorted in the display to follow how they are displayed on the chart. As the lines on the chart move (e.g. moving a stop up), the lines in trade point grid control 110 can move to follow their position on the chart. In one exemplary embodiment, trade point grid control 110 can color code each row placed into the trade point grid control 110, such as using blue to represent the entry order, pink to represent the stop order, green to represent profit targets, cream to represent a divest order, turquoise to represent an invest order, brown to represent that a go flat control has been activated so that the position is flat (i.e. all positions are exited), or in other suitable manners.

Trade summary control 112 can provide summary statistics about the trade as a whole in the following categories: realized PNL (statistics on the realized profit or loss of the closed positions), unrealized PNL (statistics on the open positions), go flat PNL (statistics if the trade was exited immediately, such as the sum of realized PNL and unrealized PNL), stop PNL (statistic if the stop is hit), plan complete PNL (statistic if all targets in the trade plan are hit), and other suitable data. Each summary line can include the following information: “R” (the number of “R” or risk units gained or lost), quantity (lots involved in the calculation), pip yield (average pip yield per lot traded), PNL (dollars gained or lost in this trade) or other suitable information.

Although the summary statistics provided by trade summary control 112 are listed as realized PNL, unrealized PNL, go flat PNL, stop PNL, plan complete PNL, other suitable summarizing values can also or alternatively be displayed.

Quick trade, parameter and trade log control 114 allows a user to select quick trade control panel 302, parameter display 202, the trade log control panel or other suitable panels. In one exemplary embodiment, each selected panel activates related functionality of dynamic trading interface 102.

Currency bar display control 116 provides an interactive control interface for placing trades, stop orders (also known as stops, which are orders to divest some or all lots at a predetermined price) and targets (orders to divest some or all of an asset at a predetermined price) that works in conjunction with settings in other controls of dynamic trading interface 102.

In one exemplary embodiment, the user can configure dynamic trading interface 102 to allow the user to initiate a trade by “clicking” (i.e. placing a cursor at a location on the chart and then activating a control button on a mouse, by using a touch screen interface and tapping or selecting one or more pop-up controls, or other suitable user interface device) on the chart anywhere under a price if the user presently holds the charted position, by clicking on the chart anywhere over price if the user is short of the charted position, or in other suitable manners. Dynamic trading interface 102 allows a user to click on the chart instead of using the more complex enter now controls. In another exemplary embodiment, a user can click twice on the chart to enter an order, where the first click sets the stop and the second click enters the trade. Additional trading functionality using currency bar display control 116 in conjunction with other controls of dynamic trading interface 102 are described in further detail herein. Although currency bar display control 116 is referred to as a “currency” bar, other suitable trading assets can also or alternatively be displayed, such as a financial instrument, security instrument, equity instrument, bond, commodity, option, future, derivative or other suitable trading assets.

Time control 118 allows a user to quickly change the time range for a selected currency pair or other suitable trading quantity shown in currency bar display control 116, such as to expand or contract the displayed time range, to scroll the current display window along the time range, or in other suitable manners. In one exemplary embodiment, time control 118 can include an adjustable slider bar that dynamically changes the time period displayed in currency bar display control 116, such as by decreasing the displayed time period as the slider bar length is decreased and increasing the displayed time period as the slider bar length is increased. Likewise, the location of the slider bar along time control 118 can be used to change the time period displayed in currency bar display control 116, such as by shifting the slider bar left or right. In this manner, a user can quickly adjust the settings of currency bar display control 116 to allow the user to subsequently place trades without having to enter values into other control panels, and also allows the user to interactively see the relative locations of trades, stops or targets with respect to a user-selected time period.

Rate control 120 allows a user to readily change the scale of the rate values of currency bar display control 116. In one exemplary embodiment, a user can place a cursor on rate control 120 and can select a first user interface device control such as the right mouse button, to allow the rate value scale to increase when the cursor is subsequently moved up towards the top of dynamic trading interface 102, and to decrease when the cursor is subsequently moved down towards the bottom of dynamic trading interface 102. In another exemplary embodiment, a user can place the cursor on rate control 120 and can select a second user interface device control such as the left mouse button, to allow the displayed chart to be moved up or down within the current settings of currency bar display control 116. In this manner, a user can quickly adjust the settings of currency bar display control 116 to allow the user to subsequently place trades without having to enter values into other control panels, and also allows the user to interactively see the relative locations of trades, stops or targets with respect to a user-selected time period.

In one exemplary embodiment, dynamic trading interface 102, trader interface 520, trade management system 510 and market interface 530 (collectively referred to as “the modules” for this exemplary embodiment) can translate a trader's instructions into market instructions (orders) in collaboration with each other. By mapping “invest” and “divest” orders to buy and sell orders, the present disclosure insulates a trader from the underlying mechanics of the markets.

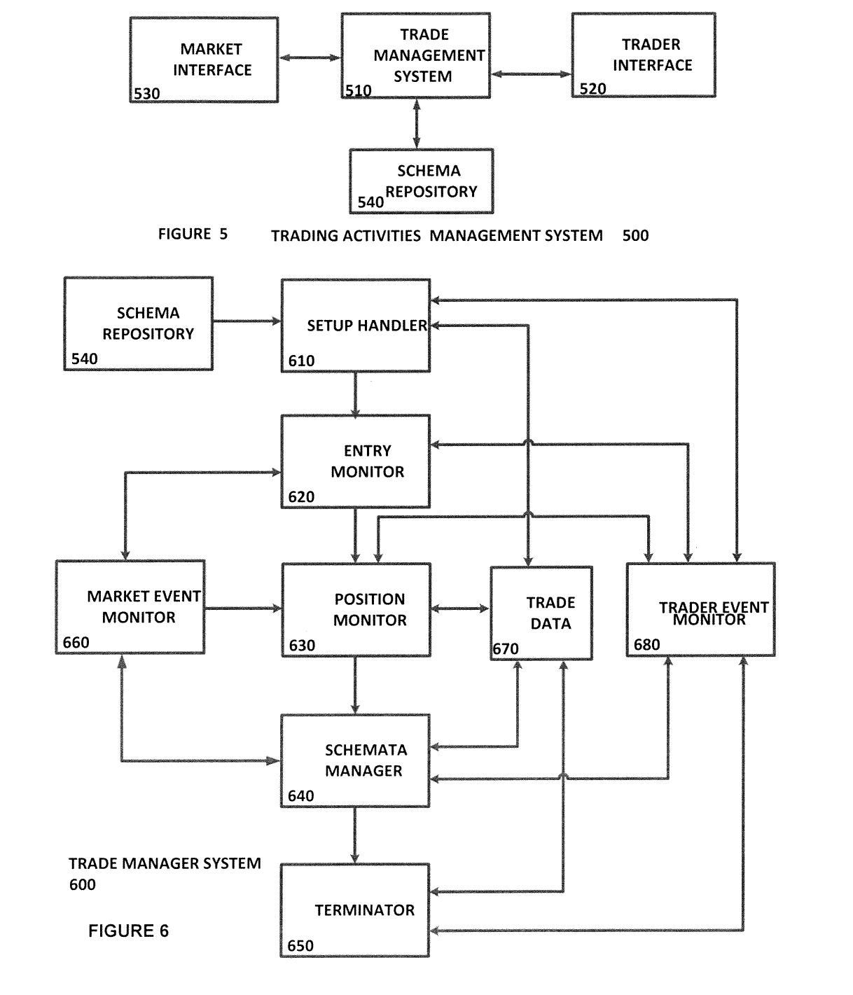

For example, when a trader activates an “invest” control using dynamic trading interface 102, which is an order to increase holdings of an asset, the modules translate the “invest” control into the associated buy or sell orders, as required by the type of position being traded (e.g. long or short) and interact with market interface 530 (discussed in greater detail below in regards to FIG. 5) for fulfillment. Accordingly, some “invest” orders are translated to buy orders (such as where a trade is buying positions or going long) and some to sell orders (such as where a trader is selling positions or going short), as dictated by the context of the trade-in-progress.

Likewise, “divest” orders (to decrease holdings of an asset) are translated into suitable sell or buy orders, as required by the type of position being traded, and issuing them to the market for fulfillment. Accordingly, some “divest” orders are translated to buy orders (such as to cover short sales) and some to sell orders (such as to sell long positions), as dictated by the context of the trade-in-progress.

In this manner, the present disclosure insulates the trader from the mechanics of the market and maps orders to the market as a function of the trade-in-progress. For example, when a trader clicks on currency bar display control 116, the modules use the type of trade (e.g. long or short), the state of the trade, the relationship of the click to the price of the asset at the moment and other relevant factors in order to generate the corresponding buy and sell orders without additional input from the user, such as market orders, limit orders, stop orders and stop-limit orders, alone or in suitable combinations.

In operation, dynamic trading interface 102 allows a user to configure controls to place trades, stops and targets with an interactive user interface device such as a mouse. In this manner, the user can quickly place trades, set stops or set targets to adjust for sudden changes in the market for the currency or other trading quantity being displayed in currency bar display control 116.

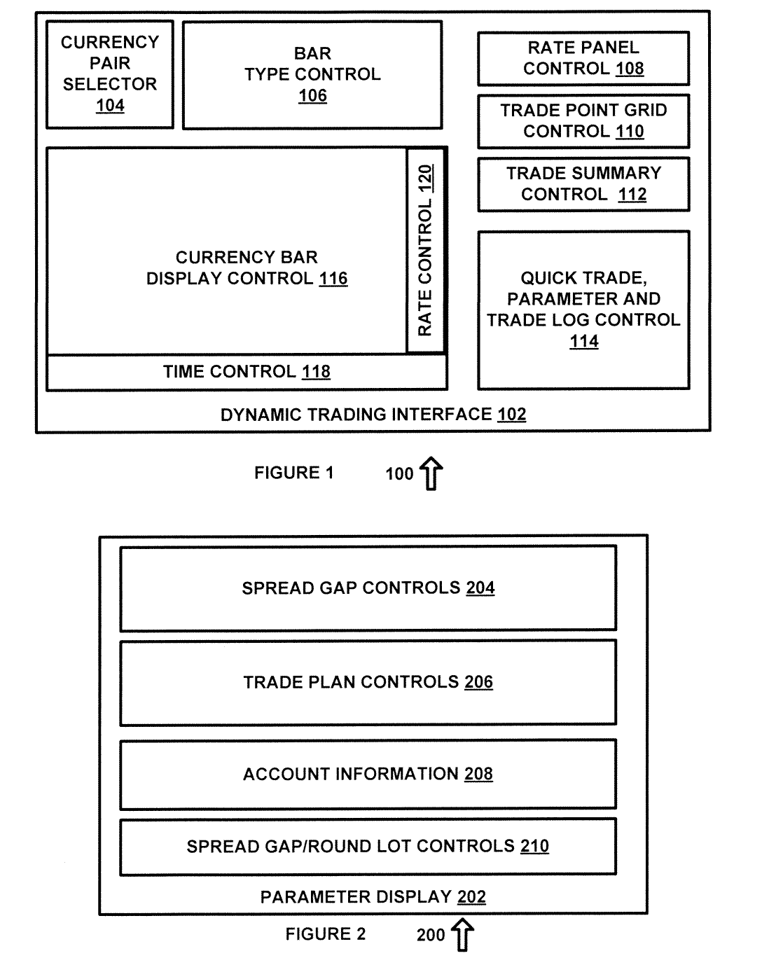

FIG. 2 is a diagram of a user interface 200 for providing dynamic coordinated functionality in accordance with an exemplary embodiment of the present disclosure. User interface 200 can be implemented in hardware or a suitable combination of hardware and software, and can be a display generated by software operating on a general purpose processor.

User interface 200 includes parameter display 202, spread gap controls 204, trade plan controls 206, account information control 208 and spread gap/round lot controls 210, each of which can be implemented as one or more objects, each having associated graphic, data and functional attributes or in other suitable manners. In addition, each object can interface with one or more other objects of user interface 200 or other user interfaces described herein. Parameter display 202 can be selected from one of a plurality of tabs of quick trade, parameter and trade log control 114, such as where the functionality of parameter display 202 is independent of the functionality of quick trade and trade log controls, as described further herein.

Spread gap controls 204 provides a small space (or buffer) that is added to line placement within currency bar display control 116 to compensate for the chart plotting a price that is between a bid price and an ask price. In one exemplary embodiment, the bid price can be 50 percent of the spread below the plotted price and the ask price can be 50 percent of the spread above the mid price, or other suitable allocations can be used. In one exemplary embodiment, a trader that holds a position (i.e. that is “long” on the position) may want to put a stop just below a predetermined price, so as to cause a trade to be initiated when the position price reaches that price, to prevent subsequent losses. In this exemplary embodiment, the stop can be executed when the bid price reaches the stop line. Visually, the bar price is a bit above (one half of the spread) the stop line. This causes orders to appear to execute above (or below, if short) the expected price. The spread gap control allows a user to further configure the spread gap, such as to use a spread gap of ½ the average spread plus 1 tick. In this exemplary embodiment, if the average spread is 1 pip, the spread gap would be set to 0.6 pips (0.5+0.1), which gives enough room for the mid price to double bottom with a pivot and not prematurely execute a trade.

In another exemplary embodiment, spread gaps can be calculated at the exact moment of the trade, where the spread gap is defined as a percentage of the current spread. In this exemplary embodiment, when the user places the cursor at a location on the currency bar display control 116 and “clicks” on the chart, the current bid/ask spread for the currency being displayed on currency bar display control 116 can be used to calculate a percentage that can be used for the spread gap. In one exemplary embodiment, spread gap control 204 can be used with anchored chart clicks and not enabled for use on a free chart click, can apply to both stop and target line placement, and can have other user-selectable configurations.

When a trader clicks on currency bar display control 116 in order to specify a price (or uses other suitable interface controls, such as voice or touch screen), trade management system 510 (discussed in greater detail below in regards to FIG. 5) receives data from the interface control and processes the data as a function of the currently selected operating mode for placing exchange rates/price points, such as “anchored,” “free” or other suitable modes. Trade management system 510 subsequently processes the data based upon a selected exchange rate, price or equivalent which establishes a buy point or a sell point, where the buy point or sell point is derived from the interface control data.

When operating in “anchored” mode, trade management system 510 can use one of the high, low, open or close functions of the currency bar which is under the mouse cursor, and depending on buy or sell context, establishes the price. If no currency bar is actually under the mouse cursor, the bar that is on the vertical line extending from the top to the bottom of the currency bar display control 116, through the mouse cursor can be used to establish the selected price, exchange rate or equivalent.

When operating in “free” mode the price, exchange rate or equivalent can be established at the precise point where the mouse click (or other user interface action) takes place without reference a price bar on currency bar display control 116.

Trade management system 510 further allows adjustments to the price selected by a click on currency bar display control 116 as a function of one or more user-selected controls such as “spread gap”, where a user specifies a fixed amount, or other suitable adjustments in order to arrive at the final price to be applied to an order.

Trade plan controls 206 can be implemented using a drop-down box and a series of buttons, such as ‘N’, ‘C’, ‘S’, ‘D’, ‘+Row’, ‘−Row’ and other suitable controls that are used to define trade plans. The drop-down box can be used to select an already defined trade plan to view, edit or copy. The ‘N’ button can be used to create a new trade plan, where selecting this button displays a box to enter the name of your new trade plan, and where a blank trade plan is displayed to allow the user to select one or more profit targets. The ‘C’ button can be used to copy an existing trade plan, where the drop-down box is used to select a trade plan to copy, and pressing the ‘C’ button will display a box to enter the name of the new trade plan. All of the trade plan elements from the original trade plan are then copied into the new trade plan, and can be edited. The ‘S’ button can be used to save a new trade plan or to save changes to an edited or copied trade plan. The ‘D’ button can be used to delete a current trade plan. The ‘+Row’ button can be used to add a new row to a trade plan. Each row becomes a profit target when a trade plan is placed. A row can further include associated items that define a profit target, such as: offset (the number of pips that the profit target is placed away from the entry rate); “R” (the factor of the trade risk at which the profit target is placed, for instance, if the distance between an initial protective stop and entry is 9 pips, the target lines will be calculated and placed as a factor of the 9 pips, where a “1 R” target will be placed 9 pips away from entry, a “½ R” target will be placed 4.5 pips away from entry, and so forth); Abs (an exact rate for this target); value (a number that matches the target type, for example 1.32355). Likewise, the ‘−Row’ button can delete the identified row from a trade plan. Each row on the trade plan becomes a divest target.

Trade plan controls 206 can also include a “takeoff” drop-down control that can be used to specify whether to divest a specific number of lots, divest a percentage of your current position, or to divest in other manners. The takeoff drop-down control can include the following controls: lots (to enter a fixed number of lots to divest); percent (to calculate a percentage of a current position to divest); value (to enter a number of lots to divest if lots are selected, or a fraction of the position to divest if percent is selected). Once a trade plan is added on the parameters tab, it will be available for use during a trade and will be visible as a trade plan drop-down box on the quick trade control panel 302.

Account information control 208 allows a user to configure an account size and a percentage to risk in a single trade, where dynamic trading interface 102 calculates the dollar risk for each trade and calculates position size. For example, if the account includes $30,000 and a risk value of 2 percent for a single trade is selected, dynamic trading interface 102 calculates the risk at $600/trade and uses that amount for each trade of a single position. In this manner, the user can configure trade size and does not need to enter a trade size for each trade, which can delay a trade until after a desired entry position has changed.

In one exemplary embodiment, trade management system can 510 manage trades according to a trade plan. Prior to beginning a trade, a trader can create a trade plan and specify it as active. As discussed further herein, trade plans can include instructions on the price, exchange rate or other suitable metrics that are used to identify whether to invest or divest a selected asset and how much of the asset to invest or divest.

In one exemplary scenario, the price and the amount to buy or sell can be fixed values. In another exemplary scenario, the price and the amount to invest or divest can be calculated at the point of entry into the market according to the trader's risk parameters, and adjusted as the trade progresses by trade management system 510.

Trade management system 510 automatically maintains the selected relationship between invest orders and divest orders that are defined by a trade plan. In one exemplary scenario, when an order is placed to enter a market, the order to enter (which is typically placed as a market order) and one or more orders to exit (which are typically placed as take-profit or stop-loss orders) are placed at the same time. As the trader's position changes, such as in response to incremental increases or decreases in position size, or when a position is closed, trade management system 510 adjusts or cancels all related orders in the currently active trade plan, including but not limited to the trade plan's take-profit or stop-loss order.

In one exemplary embodiment, the amount of the traded asset that is being bought or sold to establish the opening position is not pre-specified as a fixed amount of the traded asset, and the amount of traded asset that establishes the opening position is calculated by trade management system 510 during preparation of the entry order. In this exemplary embodiment, the opening position size can vary as a function of the difference between the asset's price, exchange rate or equivalent when the position was established, and the price, exchange rate or equivalent where the protective stop is positioned. This function holds the financial risk of the trade constant to a fixed or tightly controlled value rather than allowing it to vary with the spread between where the stop-loss order is positioned and the point of entry into the market. In this exemplary embodiment, the amount of asset that is to be bought or sold is calculated immediately prior to sending the opening order to the market as a function of the point of entry into the market, the placement of a stop-loss order and the trader's tolerance for losses.

Spread gap/round lot controls 210 allows a user to configure spread gap check controls to enable or disable the use of the ‘spread gap’ when placing a line on a chart click, and to select whether to round to the nearest lot when automatic position sizing and other lot calculations are used. If a position is rounded down to zero lots, an error can be displayed.

In operation, user interface 200 allows a user to configure parameters for trades that are implemented using dynamic trading interface 102, such as to set spread gap controls, trade plan controls, account controls or for other suitable purposes. User interface 200 allows a user to select configurations in advance to allow the user to quickly place trades, set stops and set targets using a user interface device such as a mouse without requiring the user to re-enter the information manually for each trade prior to execution, which can result in a delay that renders the trade less profitable or unprofitable.

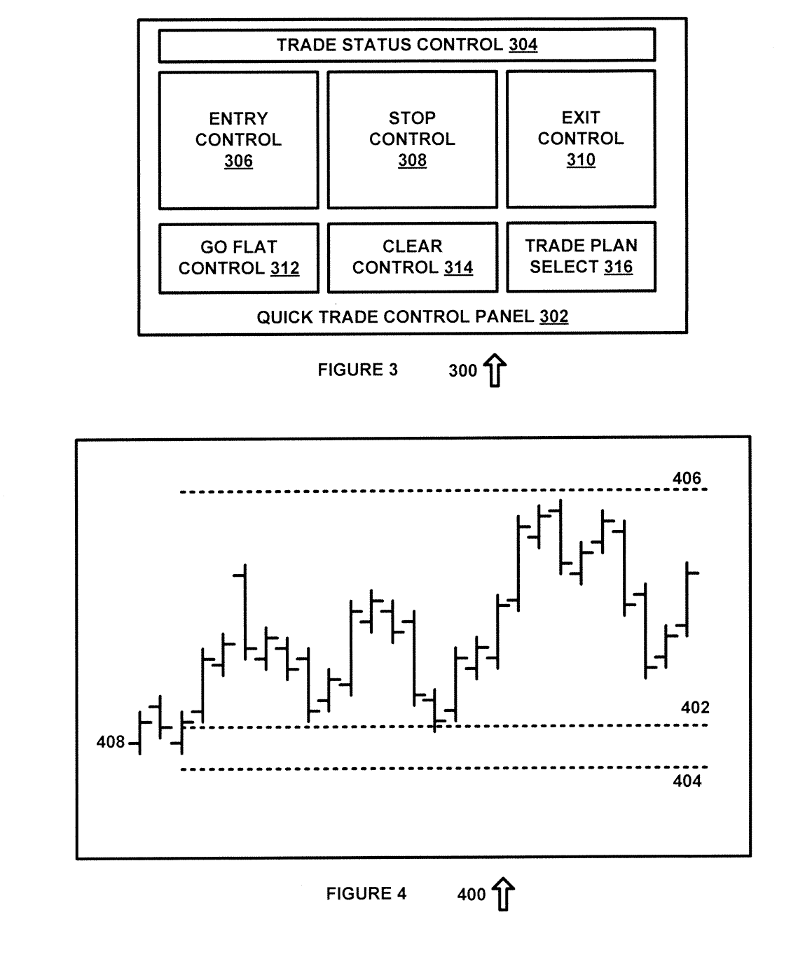

FIG. 3 is a diagram of a user interface 300 for providing dynamic coordinated functionality in accordance with an exemplary embodiment of the present disclosure. User interface 300 can be implemented in hardware or a suitable combination of hardware and software, and can be a display generated by software operating on a general purpose processor.

User interface 300 includes quick trade control panel 302, trade status control 304, entry control 306, stop control 308, exit control 310, go flat control 312, clear control 314 and trade plan select control 316 each of which can be implemented as one or more objects, each having associated graphic, data and functional attributes or in other suitable manners. In addition, each object can interface with one or more other objects of user interface 300 or other user interfaces described herein. Quick trade control panel 302 can be selected from one of a plurality of tabs of quick trade, parameter and trade log control 114, such as where the functionality of quick trade control panel 302 is independent of the functionality of quick trade and trade log controls, as described further herein.

Trade status control 304 can display the trade status for specific trade, such as using one or more of “new trade”, “waiting for initial protective stop”, “waiting for entry”, “working” or as any other suitable trade status indicators.

The initial status of trade status control 304 is “new trade.” After a long or short trade is selected, trade status control 304 will indicate that it is waiting for an initial protective stop to be selected. After the initial protective stop is placed, trade status control 304 will display “waiting for entry.” After entry, trade status control 304 will indicate when the trade has been filled, or will provide additional feedback if an action is required. For instance, if a move stop control is activated, trade status control 304 will display ‘moving stop,’ or other suitable prompts, depending on the specific action that is being taken, as described in greater detail herein.

Entry control 306 includes a number of additional controls for entry of a position, including: select position size; type of position sizing (such as automatic sizing using the lot value size entered using account information control 208 or lot numbers); select direction (such as buy or sell); and other suitable controls. Once controls for entry of a position have been selected, the user can select an initial protective stop on currency bar display control 116. In one exemplary embodiment, a dotted red line will appear at the price that the stop will be placed once the trade has been entered. In trade point grid control 110, a stop order with a status value of “raw” is generated, indicating that the stop order has not been sent to the broker yet. Trade status control 304 will display “waiting for entry,” such as where a trade is not entered until a stop has been selected. An enter market control enters the trade and causes the dotted lines on the chart turn to solid lines. A solid red line indicates the working stop order has been placed, a solid blue indicates the average fill price of the order, and additional trade plan target lines can be generated, as described below. In addition, the orders are also shown in trade point grid control 110, such as the working stop order and the filled entry order. Trade status control 304 will display a status of “filled.”

In one exemplary embodiment, entry control 306, stop control 308 and exit control 310 can be hidden until activated by a trader. When activated, the structure and behavior of entry control 306, stop control 308 and exit control 310 can be dynamically configured by trade management system 510 based on the state of the trade when such controls are activated.

In another exemplary embodiment a user can enter a market using a user interface device by placing the cursor on the chart at a price that is better than the current price. Depending on the nature of the trade, long or short, such action results in an invest order, sent as a suitable market order to buy or sell as appropriate. Similarly, a user can enter a market using a user interface device by placing the cursor on the chart at a price that is not better than the current price. Depending on the nature of the trade, long or short, such action results in an invest order, sent as a suitable limit order to buy or sell as appropriate. In this exemplary embodiment, it is possible to quickly enter the market, such as by using a first click to set a stop and a second click to enter the trade. In each case the present invention using the user's intent generates suitable orders to buy or sell, at limit or at market.

Stop control 308 allows a user to modify stop settings by entering the modified stop setting values in a control box. Alternatively, stop settings can be modified using currency bar display control 116, by placing the cursor at the desired new stop setting and activating a predetermined control on the user interface device, or in other suitable manners.

Exit control 310 allows a user to enter new target data for a trade, either by entering the new target data into control box or by selecting the new target position on currency bar display control 116 by placing the cursor at the desired new target setting and activating a predetermined control on the user interface device. In addition, a user can use exit control 310 to exit a position immediately.

Go flat control 312 allows a user to “go flat” on a position, such as by selling to cover a long position, buying to cover a short position, or to otherwise completely close out an order.

Clear control 314 allows a user to clear settings that have been entered for a trade, such as to re-enter new positions.

Trade plan select control 316 allows a user to select from one or more trade plans that have been defined using trade plan controls 206 or default trade plan settings. In one exemplary embodiment, the selected trade plan can be automatically implemented when a trade is entered, including a trade plan stop and one or more targets.

FIG. 4 is a diagram of a currency bar display control 400 in accordance with an exemplary embodiment of the present disclosure. Currency bar display control 400 includes position line 402, stop line 404 and target line 406, which are related to an order that has been placed for a currency trading pair. Historical OHLC display 408 shows the open, high, low and close positions for the currency pair for a number of predetermined periods of time, such as minutes, hours, days or other suitable periods. In conjunction with the user controls described herein, a user can enter an order by first placing a cursor at a suitable location on currency bar display control and activating a control in a user interface device, such as a mouse button, to select a stop line 404, such as by placing the cursor at a point that is under the current trading position for a buy order or at a point that is above the current trading position for a sell order. After a stop has been placed, the user can then execute the trade by placing the cursor at a suitable location on currency bar display control and activating a control in a user interface device, such as a mouse button, such as by placing the cursor at a point that is better than the current price and clicking. The user can then enter one or more target lines for divesting the position at one or more price points by clicking on each. Likewise, targets and stops can be automatically set or reset when a buy or sell order is placed. For example, if a user places an additional order for a holding or sells part of a holding, the target settings and the stop settings can be removed or re-allocated.

FIG. 5 is a diagram of a trading activities management system 500 for planning and managing trades in a variety of markets using dynamic trade management schemata in accordance with an exemplary embodiment of the present disclosure. Trading activities management system 500 manages trades using dynamic trade management schemata.

Trading activities management system 500 includes trade management system 510, trader interface system 520, market interface system 530, and schema repository system 540, which can be implemented in hardware, software, or a suitable combination of hardware and software, and which can be one or more software systems operating on a general purpose computing platform. As used herein, a software system can include one or more objects, agents, threads, functions, subroutines, separate software applications, application plug-ins, and web-browser plug-ins or other suitable software structures operating in one or more separate software applications, on one or more different processors, or other suitable hardware and software architectures. In one exemplary embodiment, a software system can include one or more lines of code or other suitable software structures operating in a general-purpose software application, such as an operating system, and one or more lines of code or other suitable software structures operating in a specific purpose software application. In another exemplary embodiment, a software system can be one or more lines in any or all of a procedural programming language, a non-procedural programming language, a functional programming language, a declarative programming language, a hypertext markup language (HTML), an extensible markup language (XML), a web browser plug-in, and other suitable code that operates in conjunction with a web browser application.

Trader interface 520 system is a system that accepts trading instructions from any combination of automated, semi-automated, manual and human sender capable of issuing such trading instructions comprising but not limited to schemata selections, amendments and adjustments to trade management schemata, entry instructions and exit instructions and makes such instructions available to trade management system 510 in a form and manner suitable for use by trade management system 510.

In one exemplary embodiment of the current disclosure, a single trader interface serves to handle any and all suitable combinations and types of automated, semi-automated, manual and human sender. In another exemplary embodiment of the current disclosure, the traffic from and for each individual type of sender is handled separately each with a suitable version of trader interface system 520, each such version handling all instances of that type. In another exemplary embodiment of the present disclosure, the traffic from and for each individual sender is handled separately each with its own individual copy of trader interface system 520, each such version handling such individual trader.

Market interface system 530 is a system that conducts instructions from trade management system 510 to the one or more markets in which positions are taken and which conducts status, reports and other such advisory information from the one or more markets to trade management system 510.

In one exemplary embodiment of the current disclosure a single market interface serves to handle any and all suitable combinations and types of market. In another exemplary embodiment of the current disclosure, the traffic from and for each individual type of market is handled separately each with a suitable version of market interface system 530, each such version handling all instances of that type. In another exemplary embodiment of the present disclosure, the traffic from and for each individual market is handled separately each with its own individual copy of market interface system 530, each such version handling such individual market.

Schema repository system 540 is a storage repository for dynamic trade management schemata. Each such schema provides the protocol, and instructions for managing one or more trades for use by trade management system 510.

In operation, trading activities management system 500 manages positions in one or more markets, establishing them and liquidating them according to one or more dynamic trade management schemata. Trading activities management system 500 allows for the acquisition of positions and disposition of positions at once or incrementally according to the instructions and protocols specified by the dynamic trade management schemata stored in schema repository system 540. Further, once the one or more dynamic trade management schemata residing in schema repository system 540 are identified to trade management system 510, and once a point of entry into the market is identified to trade management system 510 by trader interface system 520, the management of such trade is managed without any requirement for additional trader intervention. However, trader intervention, should it be necessary, convenient or desirable may be provided to trade management system 510 by trader interface system 520 during the interval that a trade is open at which time trade management system 520 shall act on the instructions of such intervention.

FIG. 6 is a diagram of a process for managing a trade in accordance with an exemplary embodiment of the present disclosure. Trade manager system 600 performs the functions required to manage a trade using trade management schemata.

Trade manager system 600 comprises a setup handler system 610, an entry monitor system 620, a position monitor system 630, a schemata manager system 640, a terminator system 650, a market event monitor system 660, a trade data system 670, and trader event monitor 680, and references schema repository system 540 which can be implemented in hardware, software, or a suitable combination of hardware and software, and which can be one or more software systems operating on a general purpose server platform. As used herein, a software system can include one or more objects, agents, threads, functions, subroutines, separate software applications, two or more lines of code or other suitable software structures operating in two or more separate, software applications, on two or more different processors, or other suitable software architectures. In one exemplary embodiment, a software system can include one or more lines of code or other suitable software structures operating in a general-purpose software application, such as an operating system, and one or more lines of code or other suitable software structures operating in a specific purpose software application. In another exemplary embodiment, a software system can be one or more lines of hypertext markup language (HTML), extensible markup language (XML), a web browser plug-in, or other suitable code that operates in conjunction with a web browser application.

Setup handler system 610 is a system that uses one or more trade management schemata contained in schema repository system 540, uses and updates the trade data of system 670 and uses trader instructions received from trader event monitor system 680 in order to mediate the setup of a developing trade.

Entry monitor system 620 is a system that monitors information from market event monitor system 660, setup handler system 610, and trader event monitor system 680 in order to configure the point at which entry into the market should occur. Setup handler system 610 provides updates to trade data system 670 as necessary to maintain context.

Position monitor system 630 is a system that monitors position in real-time, using the configuration provided by entry monitor system 620 and conditioned by trader event monitor system 680 and market event monitor system 660. Position monitor system 630 uses and updates the information of trade data system 670.

Schemata manager system 640 is a system that monitors the market events of market event monitor system 660, position information of position monitor system 630, information of the trade data system 670, and trader events of trader event monitor system 680 in order to interpret and effect commands to and from a trader, to interpret and effect orders to and from a market and to provide suitable information about such market orders the trader. Schemata manager system 640 uses and updates the information of trade data system 670. All such commands from the trader and all such orders to the market and such order's resolution are reflected in the currently operating one or more trade management schemata in use by schemata manager system 640 and in the trade data maintained by trade data system 670. In that regard, schemata manager system 640 continually maintains and manages a trade as a whole, rather than as individual orders to and responses from a market.

Terminator system 650 is a system that monitors information of the schemata manager system 640, and the trader event monitor system 680 in order to mediate the termination of an in-progress trade. Terminator system 650 uses and updates the information of trade data system 670.

Market event monitor system 660 sends commands to and receives information from market interface system 530.

Trade data system 670 inventories the information that comprises the context of the current trade, accepting updates from various other systems, and disseminating trade data information to various other systems on request.

Trader event monitor system 680 monitors commands from and issues commands to trader interface system 620, which in turn issues and receives commands from one or more traders.

In operation trade management system 600 manages trades as they setup, develop and complete. Trade management system 600 manages the setup, pre-entry, post-entry, exit and post-exit elements of a trade (“trade life cycle”)

A trade life cycle begins when trader event monitor system 680 receives one or more trade schemata selections from a trader.

Trader event monitor system 680 informs setup handler system 610 of such one or more schema selections, which adjusts and configures the trading environment to conform to the instructions and intent received from a trader.

At a point later in time, a trader makes known to trader event monitor system 680 that it wishes to identify a trading opportunity. Trader event monitor system 680 notifies setup handler system 610 and entry monitor system 630 that such trading opportunity exists. Setup handler system 610 configures the environment for the entry configuration conditioned by current market conditions as indicated by information from market event monitor system 660, the currently operating one or more trade schemata, and the nature of the trading opportunity indicated by trader event monitor system 680.

Entry monitor system 620 begins to monitor the market, using information from market event monitor system 660, for an opportunity to enter the market according to the trading instructions and trading configuration expressed by the currently operating one or mere trade management schemata (“conditions for entry”). When entry monitor system 620 determines that the one or more conditions for entry are met, entry monitor system 620 issues an entry order to market event monitor system 660 according to the one or more currently operating trade management schemata. The entry monitor system 620 crafts an entry order to the market such that the relationship among the probable fulfillment price, the size of the entry order to the market and the location and nature of the one or more stop-loss orders within the one or more operating trade management schemata are such to cause a one U loss if such one or more stop-loss orders are executed.

Entry monitor system 620 monitors for a fulfillment notification from market event monitor system 660. When entry monitor system 620 is notified of a successful fulfillment for entry into the market by market event monitor system 660, entry monitor system 620 notifies position monitor system 630 of such fulfillment.

Position monitor system 630 begins to monitor the position as progresses and unfolds. Additionally, position monitor system 630 uses and updates the information of trade data system 670 and provides information about the position to and for use by schemata manager system 640 and for use by trader event monitor system 680.

When the trading instructions expressed by the currently operating one or mere trade management schemata, as compared to the current market situation indicate that profit-taking or stop-loss conditions (“conditions for exit”) have been met, schemata manager system 640 effects such exit in accordance with the one or more trade management schemata by issuing one or more suitable orders to market event monitor system 660.

Schemata manager system 640 then waits for a notification of fulfillment from market event monitor system 660. When such fulfillment has occurred, schemata manager system 640 causes adjustments to the data of trade data system 670 and notifies trader event monitor system 680 of the change in circumstance.

When such exit results in a remaining holding of position, schemata manager system continues to manage such position. When such exit results in no remaining holding of position, terminator system 650 is advised that no position is currently held. Terminator system 650 performs its post-exit processing comprising but not limited to updating the information of trade data system 670 and notifying trader event monitor system 680 of the completion of such trade.

In some exemplary circumstances a trader adjusts and amends the one or more operating trade management schemata during the progress of the trade in response to market conditions as they unfold. Trader event monitor system 680 detects such adjustments and amendments and makes such adjustments and amendments available to schema manager system 640. Schemata manager system 640 effects one or more adjustments and amendments to the currently operating one or more schemata and zero or more adjustments and amendments to the currently extant position in response to the adjustments and amendments to the currently operating one or more trade management schemata indicated by trader event monitor system 680.

In an exemplary embodiment of the present disclosure, schema repository system 640 inventories one or more trade management schemata, each optionally named for convenience of reference and convenience of use. A trade management schema comprises one or more entry conditions each of which specify an entry point for the trade in absolute or relative terms and the initial position size in absolute or relative terms, one or more take-profit exits each of which specify a take-profit exit point for the trade in absolute or relative terms and an exit position size in absolute or relative terms, and one or more stop-loss exits which specify a stop-loss exit point in absolute or relative terms and an exit position size in absolute or relative terms.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A control apparatus comprising:
a first user configurable control interface configured to generate a display containing a plurality of function types and to receive a first function type selection;
a second user configurable control interface configured to generate a display containing a plurality of parameters associated with the selected function type and to receive a parameter selection;
a chart interface configured to display historical data for a variable and to receive a first cursor selection and a second cursor selection from a user interface device control and to generate chart location data associated with the first cursor selection and the second cursor selection; and
a function controller configured to receive the location data associated with the first cursor selection and to execute a second related function using the selected parameter if the chart location data associated with the first cursor selection is contained within a set of predetermined allowable location data for the second related function and to execute the selected function after execution of the second related function if the chart location data associated with the second cursor selection is contained within a set of allowable location data associated with the first selected function.

2. The control apparatus of claim 1 wherein the plurality of function types include an invest function and a divest function.

3. The control apparatus of claim 2 wherein the invest function is configured to translate invest orders into buy and sell orders.

4. The control apparatus of claim 2 wherein the divest function is configured to translate divest orders into buy and sell orders.

5. The control apparatus of claim 1 wherein the plurality of parameters comprise a number of lots, a number of stop loss points and a number of profit target points.

6. The control apparatus of claim 1 wherein the function controller executes a first selected buy function if the chart location data associated with the second cursor selection is below a current value of the variable.

7. The control apparatus of claim 1 wherein the function controller executes a selected sell function if the chart location data associated with the second cursor selection is above a current value of the variable.

8. The control apparatus of claim 1 wherein the function controller executes a selected buy function if the chart location data associated with the second cursor selection is below a current value of the variable and executes a second related stop order if the chart location data associated with the first cursor selection is below the current value of the variable.

9. The control apparatus of claim 1 wherein the function controller executes a selected sell function if the chart location data associated with the second cursor selection is above a current value of the variable and executes a second related stop order if the chart location data associated with first cursor selection is above the current value of the variable.

10. The control apparatus of claim 1 wherein the function controller executes a selected buy function if the chart location data associated with the second cursor selection is below a current value of the variable, executes a second related stop order if the chart location data associated with the first cursor selection is below the current value of the variable, and executes a third target order at a value above the current value of the variable.

11. The control apparatus of claim 1 wherein the function controller executes a selected sell function if the chart location data associated with the second cursor selection is above a current value of the variable, executes a second related stop order if the chart location data associated with first cursor selection is above the current value of the variable, and executes a third target order at a value below the current value of the variable.

12. A control method comprising:
generating a first user configurable control interface to display a plurality of function types and to receive a first function type selection;
generating a second user configurable control interface to display a plurality of parameters associated with the selected function type and to receive a parameter selection;
generating a chart interface to display historical data for a variable and to receive a first cursor selection and a second cursor selection from a user interface device control to generate chart location data associated with the first cursor selection and the second cursor selection; and
generating a function controller to receive the location data associated with the first cursor selection and to execute a second related function using the selected parameter if the chart location data associated with the first cursor selection is contained within a set of predetermined allowable location data for the second related function and to execute the selected function after execution of the second related function if the chart location data associated with the second cursor selection is contained within a set of allowable location data associated with the first selected function.

13. The control method of claim 12 wherein the plurality of function types include a buy function and a sell function.

14. The control method of claim 12 wherein the plurality of parameters comprise a number of lots, a stop and a target.

15. The control method of claim 12 wherein the function controller executes a first selected buy function if the chart location data associated with the second cursor selection is below a current value of the variable.

16. The control method of claim 12 wherein the function controller executes a selected sell function if the chart location data associated with the second cursor selection is above a current value of the variable.

17. The control method of claim 12 wherein the function controller executes a selected buy function if the chart location data associated with the second cursor selection is below a current value of the variable and executes a second related stop order if the chart location data associated with the first cursor selection is below the current value of the variable.

18. The control method of claim 12 wherein the function controller executes a selected sell function if the chart location data associated with the second cursor selection is above a current value of the variable and executes a second related stop order if the chart location data associated with first cursor selection is above the current value of the variable.

19. The control method of claim 12 wherein the function controller executes a selected buy function if the chart location data associated with the second cursor selection is below a current value of the variable, executes a second related stop order if the chart location data associated with the first cursor selection is below the current value of the variable, and executes a third target order at a value above the current value of the variable.

20. The control method of claim 12 wherein the function controller executes a selected sell function if the chart location data associated with the second cursor selection is above a current value of the variable, executes a second related stop order if the chart location data associated with first cursor selection is above the current value of the variable, and executes a third target order at a value below the current value of the variable.
